(19) United States
(12) Patent Application Publication
(10) Pub. No.: US 2016/0260993 A1
(43) Pub. Date: Sep. 8, 2016

(54) SINGLE FUEL CELL AND METHOD OF MANUFACTURING SINGLE FUEL CELL

(71) Applicant: TOYOTA JIDOSHA KABUSHIKI KAISHA, Toyota-shi (JP)

(72) Inventor: Kotaro IKEDA, Susono-shi (JP)

(73) Assignee: TOYOTA JIDOSHA KABUSHIKI KAISHA, Toyota-shi (JP)

(21) Appl. No.: 15/057,290

(22) Filed: Mar. 1, 2016

(30) Foreign Application Priority Data
Mar. 3, 2015 (JP) 2015-041751

(51) Int. Cl. H01M 8/1004; H01M 8/0284; H01M 8/0273

(52) U.S. Cl. CPC H01M 8/1004; H01M 8/0273; H01M 8/0284

(57) ABSTRACT

A single fuel cell includes: a membrane electrode assembly; gas diffusion layers placed on both side surfaces of the membrane electrode assembly, respectively, while an outer peripheral edge portion remains in one side surface of the membrane electrode assembly; an adhesive layer formed to cover the outer peripheral edge portion; a support frame fixed on the adhesive layer; and separators placed on both side surfaces of the support frame and the gas diffusion layers, respectively, so that the peripheral portions of the separators are fixed on the support frame and the central portions of the separators abut on the gas diffusion layers. The support frame includes: a support frame body; and adhesive coating layers formed of an adhesive with thermoplasticity on at least one of both side surfaces of the support frame body.

### BACKGROUND

1. Field of the Invention

The present invention relates to a single fuel cell and a method of manufacturing a single fuel cell.

2. Description of the Related Art

There has been known a single fuel cell including: a membrane electrode assembly in which electrocatalyst layers are formed on both side surfaces of an electrolyte membrane, respectively; gas diffusion layers which are placed on both side surfaces of the membrane electrode assembly, respectively, while an outer peripheral edge portion remains in one side surface of the membrane electrode assembly; an adhesive layer which is formed to cover the outer peripheral edge portion; a support frame which is fixed on the adhesive layer; and separators which are placed on both side surfaces of the support frame and the gas diffusion layers, respectively, so that peripheral portions of the separators are fixed on the support frame and central portions of the separators abut on the gas diffusion layers, wherein the support frame includes: a support frame body; and adhesive coating layers which are formed of an adhesive with thermoplasticity on both side surfaces of the support frame body, the separators are formed of a metal; and the support frame body is formed of an insulating film such as polypropylene or polyethylene (see, for example, Patent Literature 1).

### CITATION LIST

### Patent Literature

[Patent Literature 1] Japanese Laid-open Patent

### Publication No. 2013-251253

The above-described single fuel cell has a structure in which the separators are fixed to the support frame with the thermoplastic adhesive. In such a structure, not only the adhesive but also a wide region including the separators and the support frame in the neighborhood of the adhesive is heated when the adhesive is heated to adhere the separators and the support frame to each other. In such a case, the shrinkage of the support frame is greater than the shrinkage of each of the separators in a cooling process after the heating when the linear expansion coefficient of the support frame is greater than the linear expansion coefficient of each of the separators and the difference between both of the linear expansion coefficients is large. Thus, the membrane electrode assembly is under a tension by the support frame via the adhesive layer from the neighborhood of the membrane electrode assembly, undergoes a large tensile load, and may be ruptured. As a result, cross leakage may occur. Particularly when a metal is used as the material of the separators and a polymer which is a high-molecular compound is used as the material of the support frame, a large tensile load is prone to be applied to the membrane electrode assembly due to the large difference between the linear expansion coefficients of the materials.

Desired is the technology of inhibiting a large tensile load from being applied to a membrane electrode assembly even when a metal is used as the material of a separator and a polymer is used as the material of a support frame.

### SUMMARY OF THE INVENTION

In accordance with an aspect of the present invention, there is provided a single fuel cell, comprising: a membrane electrode assembly including an electrolyte membrane and electrocatalyst layers formed on both side surfaces of the electrolyte membrane, respectively; gas diffusion layers placed on both side surfaces of the membrane electrode assembly, respectively, so that an outer peripheral edge portion remains in one side surface of the membrane electrode assembly; an adhesive layer formed to cover the outer peripheral edge portion; a support frame fixed on the adhesive layer; and separators placed on both side surfaces of the support frame and the gas diffusion layers, respectively, so that peripheral portions of the separators are fixed on the support frame and central portions of the separators abut on the gas diffusion layers, wherein the support frame comprises: a support frame body; and an adhesive coating layer formed of an adhesive with thermoplasticity on at least one of both side surfaces of the support frame body, the separators are formed of a metal; and the support frame body is formed of a stretched crystalline polymer.

In accordance with another aspect of the present invention, there is provided a method for manufacturing a single fuel cell, the single fuel cell including: a membrane electrode assembly including an electrolyte membrane and electrocatalyst layers formed on both side surfaces of an electrolyte membrane, respectively; gas diffusion layers placed on both side surfaces of the membrane electrode assembly; a support frame supporting the membrane electrode assembly on a periphery of the membrane electrode assembly; and separators placed on both side surfaces of the support frame and the gas diffusion layers, respectively, so that peripheral portions of the separators are fixed on the support frame and central portions of the separators abut on the gas diffusion layers, wherein the support frame includes: a support frame body; and an adhesive coating layer formed of an adhesive with thermoplasticity on at least one of both side surfaces of the support frame body; the separators are formed of a metal; and the support frame body is formed of a stretched crystalline polymer, the method for manufacturing the single fuel cell, comprising: providing the membrane electrode assembly in which the gas diffusion layers are placed on both side surfaces of the membrane electrode assembly, respectively, while an outer peripheral edge portion remains in one side surface of the membrane electrode assembly; forming an adhesive layer to cover the outer peripheral edge portion; placing an interior portion of the support frame on the adhesive layer and adhering the support frame and the membrane electrode assembly to each other; and placing the peripheral portions of the separators on both side surfaces of an outer portion of the support frame adhered to the membrane electrode assembly and heating the support frame and the separators to be adhered to each other.

A large tensile load can be inhibited from being applied to a membrane electrode assembly even when a metal is used as the material of a separator and a polymer is used as the material of a support frame.

### BRIEF DESCRIPTION OF THE DRAWINGS

FIG. 1 is an exploded perspective view schematically illustrating a configuration example of a single fuel cell;

FIG. 2 is a partial cross-sectional view illustrating a configuration example of a fuel cell stack including a single fuel cell;

FIG. 3 is a partially enlarged view of FIG. 2;

FIG. 4 is a partial cross-sectional view illustrating a configuration example of a fuel cell stack including a single fuel cell;

FIG. 5 is a partial cross-sectional view illustrating a configuration example of a flow passage member;

FIG. 6 is a partial cross-sectional view illustrating the steps of a method of manufacturing a single fuel cell;

FIG. 7 is a partial cross-sectional view illustrating the steps of the method of manufacturing a single fuel cell;

FIG. 8 is a partial cross-sectional view illustrating the steps of the method of manufacturing a single fuel cell;

FIG. 9 is a partial cross-sectional view illustrating the steps of the method of manufacturing a single fuel cell;

FIG. 10 is a partial cross-sectional view illustrating the steps of the method of manufacturing a single fuel cell;

FIG. 11 is a partial cross-sectional view illustrating the steps of the method of manufacturing a single fuel cell;

FIG. 12 is a partial cross-sectional view illustrating the steps of a method of manufacturing a single fuel cell of another embodiment;

FIG. 13 is a partial cross-sectional view illustrating the steps of the method of manufacturing a single fuel cell of the other embodiment; and

FIG. 14 is a partial cross-sectional view illustrating the steps of the method of manufacturing a single fuel cell of the other embodiment.

### DETAILED DESCRIPTION OF THE PREFERRED EMBODIMENTS

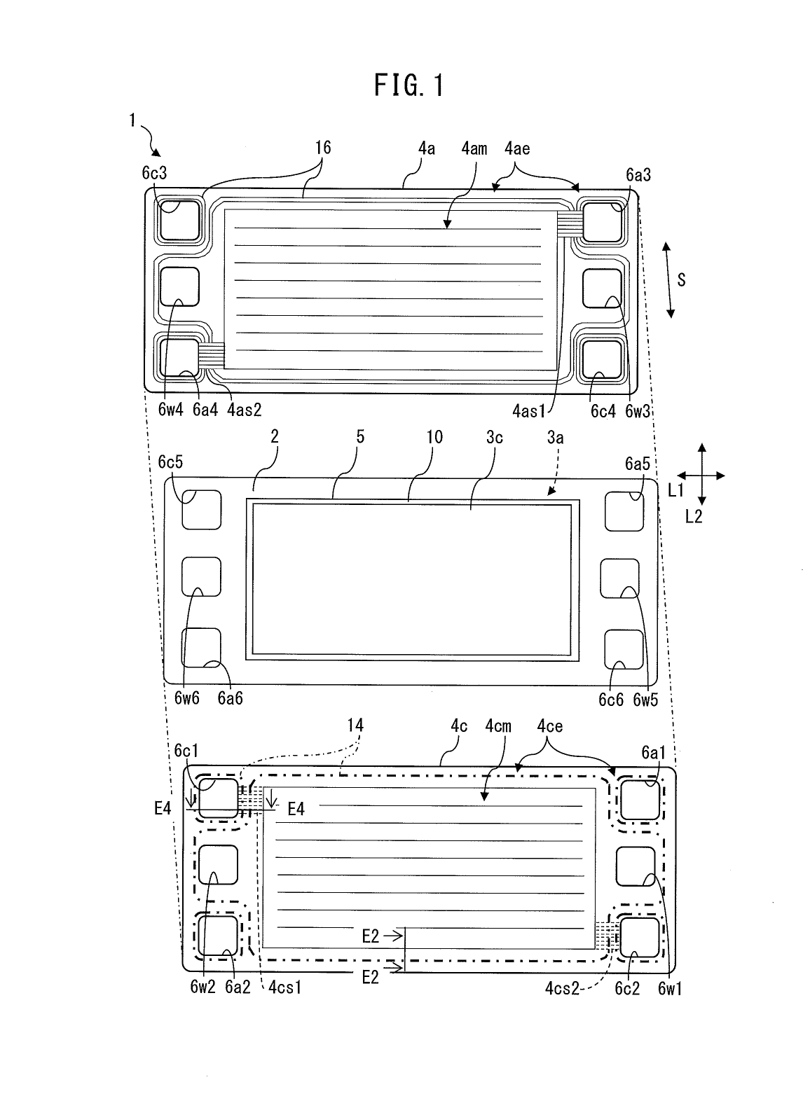

The configuration of a single fuel cell will be described. FIG. 1 is an exploded perspective view schematically illustrating a configuration example of the single fuel cell. The single fuel cell 1 includes a membrane electrode assembly 5. A cathode gas diffusion layer 3c and an anode gas diffusion layer 3a are placed on both side surfaces of the membrane electrode assembly 5, respectively, and a support frame 2 is placed on the periphery of the membrane electrode assembly 5 via an adhesive layer 10. A cathode separator 4c and an anode separator 4a are placed on both side surfaces of the membrane electrode assembly 5 and the support frame 2, respectively. Thus, the single fuel cell 1 is formed by assembling the cathode separator 4c and the anode separator 4a onto both side surfaces of the support frame 2 and the membrane electrode assembly 5 including the gas diffusion layers 3c and 3a, respectively. When viewed from the thickness direction S of the single fuel cell 1, the single fuel cell 1 has an approximately rectangular outer shape having a longitudinal direction L1 and a transverse direction L2 perpendicular to the longitudinal direction L1. Similarly, each member of the membrane electrode assembly 5, the support frame 2, each of the gas diffusion layers 3c and 3a, and each of the separators 4c and 4a, included in the single fuel cell 1, also has an approximately rectangular outer shape. Thus, the longitudinal direction and transverse direction of each member correspond to the longitudinal direction L1 and transverse direction L2 of the single fuel cell 1, respectively. Hereinafter, the longitudinal direction and transverse direction of each member are also referred to as a longitudinal direction L1 and a transverse direction L2, respectively.

A central portion 4cm of the cathode separator 4c includes plural grooves for oxidant gas feed passages in the membrane electrode assembly 5 side (the side which is not illustrated in the drawing). The plural grooves of the central portion 4cm are formed by integrally molding the cathode separator 4c. In the embodiment illustrated in FIG. 1, the grooves of the central portion 4cm are unidirectional flow passages. In another embodiment which is not illustrated, the plural grooves are serpentine-type flow passages. In a peripheral portion 4ce in the outside of the central portion 4cm in the cathode separator 4c, in the vicinities of both end portions in the longitudinal direction L1 of the cathode separator 4c, penetration ports 6c1 and 6c2 for a oxidant gas manifold, penetration ports 6w1 and 6w2 for a cooling water manifold, and penetration ports 6a1 and 6a2 for a fuel gas manifold are formed to penetrate the cathode separator 4c. Flow passage members 4cs1 and 4cs2 through which oxidant gas is guided are placed between the penetration ports 6c1 and 6c2 for a oxidant gas manifold and the plural grooves of the central portion 4cm. In another embodiment which is not illustrated, the flow passage members 4cs1 and 4cs2 are formed as parts of the cathode separator 4c by integral molding. In the side reverse to the membrane electrode assembly 5 of the peripheral portion 4ce (the side illustrated in the drawing), flat surfaces on which gasket-like sealing members 14 can be placed are formed around each penetration port and around the central portion 4cm.

A central portion 4am of the anode separator 4a includes plural grooves for fuel gas feed passages in the membrane electrode assembly 5 side (the side illustrated in the drawing). The plural grooves of the central portion 4am are formed by integrally molding the anode separator 4a. In the embodiment illustrated in FIG. 1, the plural grooves of the central portion 4am are unidirectional flow passages. In another embodiment which is not illustrated, the plural grooves are serpentine-type flow passages. In a peripheral portion 4ae in the outside of the central portion 4am in the anode separator 4a, in the vicinities of both end portions in the longitudinal direction L1 of the anode separator 4a, penetration ports 6c3 and 6c4 for a oxidant gas manifold, penetration ports 6w3 and 6w4 for a cooling water manifold, and penetration ports 6a3 and 6a4 for a fuel gas manifold are formed to penetrate the anode separator 4a. Flow passage members 4as1 and 4as2 through which fuel gas is guided are placed between the penetration ports 6a3 and 6a4 for a fuel gas manifold and the plural grooves of the central portion 4am. In another embodiment which is not illustrated, the flow passage members 4as1 and 4as2 are formed as parts of the anode separator 4a by integral molding. In the side reverse to the membrane electrode assembly 5 of the peripheral portion 4ae (the side which is not illustrated), depressions for receiving the sealing members 14 are formed around each penetration port and around the central portion 4am, and protrusions 16 are formed at corresponding positions in the membrane electrode assembly 5 side.

In the vicinities of both end portions in the longitudinal direction L1 of the support frame 2, penetration ports 6c5 and 6c6 for an oxidant gas manifold, penetration ports 6w5 and 6w6 for a cooling water manifold, and penetration ports 6a5 and 6a6 for a fuel gas manifold are formed to penetrate the support frame 2.

When the single fuel cell 1 is formed, the penetration ports 6c1, 6c5, 6c3, 6c2, 6c6, and 6c4 for an oxidant gas manifold, the penetration ports 6w1, 6w5, 6w3, 6w2, 6w6, and 6w4 for a cooling water manifold, and the penetration ports 6a1, 6a5, 6a3, 6a2, 6a6, and 6a4 for a fuel gas manifold in the cathode separator 4c, the support frame 2, and the anode separator 4a are correspondingly aligned in the thickness direction S by assembling the cathode separator 4c and the anode separator 4a on the both sides of the membrane electrode assembly 5 supported by the support frame 2. Thus, passages extending in the thickness direction S, i.e., oxidant gas manifolds, cooling water manifolds, and fuel gas manifolds as fluid flow-through passages are defined.

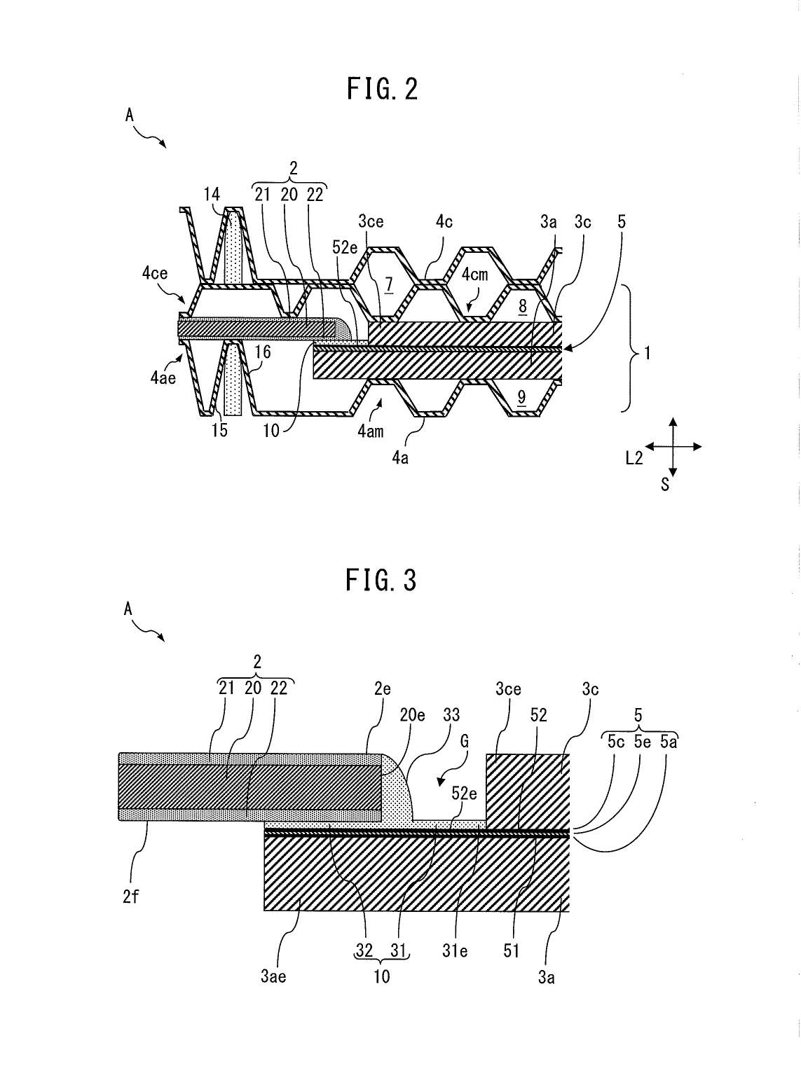

FIG. 2 is a partial cross-sectional view illustrating a configuration example of a fuel cell stack A including a single fuel cell 1. The drawing illustrates a portion corresponding to a cross section taken along the line E2-E2 of FIG. 1. FIG. 3 is a partially enlarged view of FIG. 2. A fuel cell stack is formed by a layered product in which a plurality of single fuel cells 1 are layered in the thickness direction S of the single fuel cell 1. The single fuel cell 1 generates electric power by the electrochemical reaction of fuel gas (e.g., hydrogen gas) and oxidant gas (e.g., air). The electric power generated by the single fuel cell 1 is taken to the outside of the fuel cell stack via a plurality of wiring lines from terminal plates placed on both end portions of the layered product to the outside of the fuel cell stack. The electric power taken from the fuel cell stack is fed to, for example, an electric motor for driving an electrically driven vehicle, or a capacitor.

The membrane electrode assembly 5 of the single fuel cell 1 includes an electrolyte membrane 5e as well as a cathode electrocatalyst layer 5c and an anode electrocatalyst layer 5a that are formed on both sides of the electrolyte membrane 5e. The electrolyte membrane 5e, the cathode electrocatalyst layer 5c, and the anode electrocatalyst layer 5a have similar sizes. When the cathode electrocatalyst layer 5c and the anode electrocatalyst layer 5a are placed on the both sides of the electrolyte membrane 5e to form the membrane electrode assembly 5, the electrolyte membrane 5e, the cathode electrocatalyst layer 5c, and the anode electrocatalyst layer 5a almost fit each other. In another embodiment which is not illustrated, at least one of the cathode electrocatalyst layer 5c and the anode electrocatalyst layer 5a is smaller than the electrolyte membrane 5e.

Examples of the material of the electrolyte membrane 5e include a fluorine-based polymer membrane with ionic conductivity. In the embodiment illustrated in FIG. 2, an ion exchange membrane with proton conductivity including perfluorosulfonic acid is used. Examples of the materials of the cathode electrocatalyst layer 5c and the anode electrocatalyst layer 5a include catalyst-supported carbon on which a catalyst such as platinum or platinum alloy is supported. In the embodiment illustrated in FIG. 2, catalyst-supported carbon on which platinum alloy is supported is used. In another embodiment which is not illustrated, an ionomer of the same material as that of the electrolyte membrane 5e is further added to the catalyst-supported carbon.

A cathode gas diffusion layer 3c is placed on one side surface 52 of the membrane electrode assembly 5, i.e., on the cathode electrocatalyst layer 5c, to thereby electrically connect the cathode gas diffusion layer 3c to the membrane electrode assembly 5. In addition, an anode gas diffusion layer 3a is placed on the other side surface 51 of the membrane electrode assembly 5, i.e., on the anode electrocatalyst layer 5a, to thereby electrically connect the anode gas diffusion layer 3a to the membrane electrode assembly 5. The cathode gas diffusion layer 3c has the next smaller size than that of the membrane electrode assembly 5. When the cathode gas diffusion layer 3c is placed on the side surface 52 of the membrane electrode assembly 5, an outer peripheral edge portion 52e is formed in a frame shape on the side surface 52 of the membrane electrode assembly 5 around the cathode gas diffusion layer 3c. In contrast, the anode gas diffusion layer 3a has a size similar to that of the membrane electrode assembly 5. When the anode gas diffusion layer 3a is placed on the side surface 51 of the membrane electrode assembly 5, the membrane electrode assembly 5 and the anode gas diffusion layer 3a almost fit each other.

Examples of the materials of the cathode gas diffusion layer 3c and the anode gas diffusion layer 3a include porous bodies with conductivity, e.g., carbon porous bodies such as carbon papers, carbon cloths and glasslike carbons, and metal porous bodies such as metal meshes and foam metals. In the embodiment illustrated in FIG. 2, carbon cloth is used. In another embodiment which is not illustrated, the above-described porous body is impregnated with a material with high water repellency such as polytetrafluoroethylene in such a manner that porosity is not lost. In still another embodiment which is not illustrated, a mixed layer of a material with high water repellency and carbon particles is formed on a side surface of the above-described porous body.

An adhesive layer 10 is formed on the outer peripheral edge portion 52e. The adhesive layer 10 is formed in a frame shape that is similar to that of the outer peripheral edge portion 52e. In the embodiment illustrated in FIG. 2, the adhesive layer 10 is formed on the whole surface of the outer peripheral edge portion 52e to cover the outer peripheral edge portion 52e. The adhesive layer 10 includes: an outer portion 32 located on the outside of the outer peripheral edge portion 52e in a planar direction; and an interior portion 31 located on the inside of the outer peripheral edge portion 52e in the planar direction. An end portion 31e in the inside of the interior portion 31 comes in contact with an outer portion ace of the cathode gas diffusion layer 3c.

The adhesive layer 10 is formed of an adhesive that does not have any thermosetting property but has ultraviolet (UV) curability. Examples of the material of such an adhesive layer 10 include: UV curable adhesives in which radical-polymerizable resins such as UV curable polyisobutylene resin, UV curable epoxy resin, and UV curable acrylic resin are used; and UV curable adhesives in which cationic polymerizable resins are used. In the embodiment illustrated in FIG. 2, a UV curable adhesive in which UV curable polyisobutylene resin which is a radical-polymerizable resin is used is used. Examples of a method of applying an adhesive for the adhesive layer 10 include a screen printing method and an application method with a dispenser. In the embodiment illustrated in FIG. 2, a screen printing method is used.

A support frame 2 is placed on the adhesive layer 10. The support frame 2, which has a frame shape, supports the membrane electrode assembly 5 including the cathode gas diffusion layer 3c and the anode gas diffusion layer 3a on the periphery of the membrane electrode assembly 5. In the embodiment illustrated in FIG. 3, an interior portion 2e in one side surface of the support frame 2 is adhered onto the outer portion 32 of the adhesive layer 10, whereby the interior portion 2e of the support frame 2 is adhered to the outer peripheral edge portion 52e of the membrane electrode assembly 5. When the interior portion 2e is adhered to the outer peripheral edge portion 52e, a gap G is formed between the interior portion 2e of the support frame 2 and the outer portion 3ce of the cathode gas diffusion layer 3c. In other words, the support frame 2 is placed to be spaced from the cathode gas diffusion layer 3c.

The support frame 2 includes: a support frame body 20; and adhesive coating layers 21 and 22 that are formed on both side surfaces of the support frame body 20, respectively.

The support frame body 20 is formed of a material with an electrical insulation property and airtightness. A crystalline polymer is used as the material of the support frame body 20. Examples of the crystalline polymer include engineering plastics and general-purpose plastics. Examples of the engineering plastics include polyethylene naphthalate resin (PEN), polyethylene terephthalate resin (PET), polyphenylene sulfide resin (PPS), and syndiotactic polystyrene resin (SPS). Examples of the general-purpose plastics include polypropylene resin (PP). In the embodiment illustrated in FIG. 3, polyethylene terephthalate resin which can transmit ultraviolet rays having a predetermined wavelength (e.g., 365 nm) used for curing the adhesive layer 10 is used as the material of the support frame body 20. Additional examples of materials which can transmit the ultraviolet rays having the predetermined wavelength include syndiotactic polystyrene resin (SPS) and polypropylene resin (PP).

The adhesive coating layers 21 and 22 can be adhered to the support frame body 20, both separators 4c and 4a, and the adhesive layer 10, and are formed on both side surfaces of the support frame body 20 with an adhesive having thermoplasticity by a known method. The materials of the adhesive coating layers 21 and 22 can be selected as appropriate from, for example, vinyl acetate resin adhesives, polyvinyl alcohol resin adhesives, ethylene-vinyl acetate resin adhesives, vinyl chloride resin adhesives, acrylic resin adhesives, polyamide resin adhesives, cellulosic resin adhesives, polyvinylpyrrolidone resin adhesives, polystyrene resin adhesives, cyanoacrylate resin adhesives, polyvinyl acetal resin adhesives, polyester resin adhesives, modified olefin resin adhesives, and the like, depending on the materials of the support frame body 20, both of the separators 4c and 4a, and the adhesive layer 10.

In the embodiment illustrated in FIG. 3, polyethylene terephthalate resin is used as the material of the support frame body 20. However, polyethylene terephthalate resin and polyethylene naphthalate resin, which are vulnerable to the strongly acidic atmosphere of the single fuel cell 1, may degrade. Thus, when a weak material is used in such a strongly acidic atmosphere, an adhesive protecting layer 33 which protects an end 20e from the strongly acidic atmosphere is formed on the end 20e of the support frame body 20. The material of the adhesive protecting layer 33 is not particularly limited as long as the material can protect the end 20e from the strongly acidic atmosphere, and examples of the material include the same material as that of the adhesive layer 10 and the same materials as those of the adhesive coating layers 21 and 22. The both side surfaces of the support frame body 20 are not degraded by the strongly acidic atmosphere of the single fuel cell 1 because of being protected by the adhesive coating layers 21 and 22, respectively.

A peripheral portion 4ce in one side surface of the cathode separator 4c is adhered and fixed to the other side surface of the support frame 2 with the adhesive coating layer 21. A central portion 4cm which is more interior than the peripheral portion 4ce in the one side surface of the cathode separator 4c abuts on the cathode gas diffusion layer 3c, whereby the cathode separator 4c is electrically connected to the cathode gas diffusion layer 3c. The adhesive coating layer 21 seals a cathode electrode side of the single fuel cell 1 from the outside. As illustrated in FIG. 2, plural oxidant gas feed passages 8 are formed by plural grooves for oxidant gas feed passages disposed in the central portion 4cm of the cathode separator 4c and by the cathode gas diffusion layer 3c. Oxidant gas fed from the plural oxidant gas feed passages 8 are fed to the membrane electrode assembly 5 through the cathode gas diffusion layer 3c.

In contrast, a peripheral portion 4ae in one side surface of the anode separator 4a is adhered and fixed to one side surface of the support frame 2 with the adhesive coating layer 22. A central portion 4am which is more interior than the peripheral portion 4ae in the one side surface of the anode separator 4a abuts on the anode gas diffusion layer 3a, whereby the anode separator 4a is electrically connected to the anode gas diffusion layer 3a. The adhesive coating layer 22 seals an anode electrode side of the single fuel cell 1 from the outside. As illustrated in FIG. 2, plural fuel gas feed passages 9 are formed by plural grooves for fuel gas feed passages disposed in the central portion 4am of the anode separator 4a and by the anode gas diffusion layer 3a. Fuel gas fed from the plural fuel gas feed passages 9 are fed to the membrane electrode assembly 5 through the anode gas diffusion layer 3a.

In two single fuel cells 1 adjacent to each other, the cathode separator 4c of one single fuel cell 1 and the anode separator 4a of the other single fuel cell 1 abut on each other. As a result, a cooling water feed passage 7 surrounded by two oxidant gas feed passages 8 and two fuel gas feed passages 9 is formed as illustrated in FIG. 2.

The cathode separator 4c and the anode separator 4a, which do not transmit an oxidant gas, a fuel gas, or cooling water, are formed of a material with conductivity. Examples of the materials of the cathode separator 4c and the anode separator 4a include metals such as stainless steel and titanium. The linear expansion coefficients of the materials are almost about 10×10⁻⁶/° C. Specifically, for example, the linear expansion coefficient of SUS304 is about 17×10⁻⁶/° C. while the linear expansion coefficient of titanium is about 8.4×10⁻⁶/° C.

In single fuel cells 1 adjacent to each other, the peripheral portion 4ae in the other side surface of the anode separator 4a of one single fuel cell 1 and the peripheral portion 4ce in the other side surface of the cathode separator 4c of the other single fuel cell 1 come into contact with each other via a sealing member 14 as illustrated in FIG. 2. In the embodiment illustrated in FIG. 2, the sealing member 14 placed on a flat surface of the peripheral portion 4ce fits into a depression 15 of the peripheral portion 4ae. Examples of the material of the sealing member 14 include elastic members such as rubber.

In the embodiment illustrated in FIG. 2, the support frame body 20 is further formed of a material having a linear expansion coefficient approximating each linear expansion coefficient of the cathode separator 4c and the anode separator 4a. When the support frame 2 is heated to melt the adhesive coating layers 21 and 22 and to adhere the support frame 2 and both of the separators 4c and 4a to each other, a great difference between the linear expansion coefficient of the support frame body 20 and each linear expansion coefficient of both of the separators 4c and 4a results in a great difference between the shrinkage of the support frame 2 and the shrinkage of both of the separators 4c and 4a in a subsequent cooling process or during cold operation. Then, the support frame 2 applies a large tensile load to the membrane electrode assembly 5, and cracks may be generated, for example, in the vicinity of the outer peripheral edge portion 52e of the electrolyte membrane 5e, or the like, and may cause cross leakage. A reduced difference between the linear expansion coefficient of the support frame body 20 and each linear expansion coefficient of both of the separators 4c and 4a can allow such a situation to be avoided.

Examples of the material of the support frame body 20 having a linear expansion coefficient approximating each linear expansion coefficient of both of the separators 4c and 4a include the above-described crystalline polymer which is biaxially stretched. In the embodiment illustrated in FIG. 2, biaxially-stretched polyethylene terephthalate resin is used as the material of the support frame body 20. The linear expansion coefficient of such a material before stretching is, for example, almost about 100×10⁻⁶/° C., while the linear expansion coefficient thereof in a stretching direction after the stretching can be lowered, for example, to almost about 20 to 40×10⁻⁶/° C., by the stretching. In contrast, the linear expansion coefficient of the typical material of the cathode separator 4c or the anode separator 4a is almost about 10×10⁻⁶/° C. By stretching the support frame 2 in such a manner, the linear expansion coefficient of the support frame 2 in a stretching direction can be allowed to approach each linear expansion coefficient of both of the separators 4a and 4c, and can be adjusted approximately equivalently to each linear expansion coefficient of both of the separators 4a and 4c depending on the degree of the stretching. In another embodiment which is not illustrated, the above-described crystalline polymer which is monoaxially or tri- or more multi-axially stretched, e.g., polyethylene terephthalate resin, is used. Examples of a method of manufacturing the support frame body 20, but are not particularly limited to, a method in which a film formed by a T-die casting method is stretched by a tentering method to form the support frame body. As the stretching method, for example, simultaneous biaxial stretching or successive biaxial stretching is acceptable in the case of biaxial stretching.

In particular, in the embodiment illustrated in FIG. 2, polyethylene terephthalate resin that is biaxially stretched in directions perpendicular to each other is used as the material of the support frame body 20, and the biaxial stretching directions are aligned in the longitudinal direction L1 and transverse direction L2 of the support frame 2, respectively.

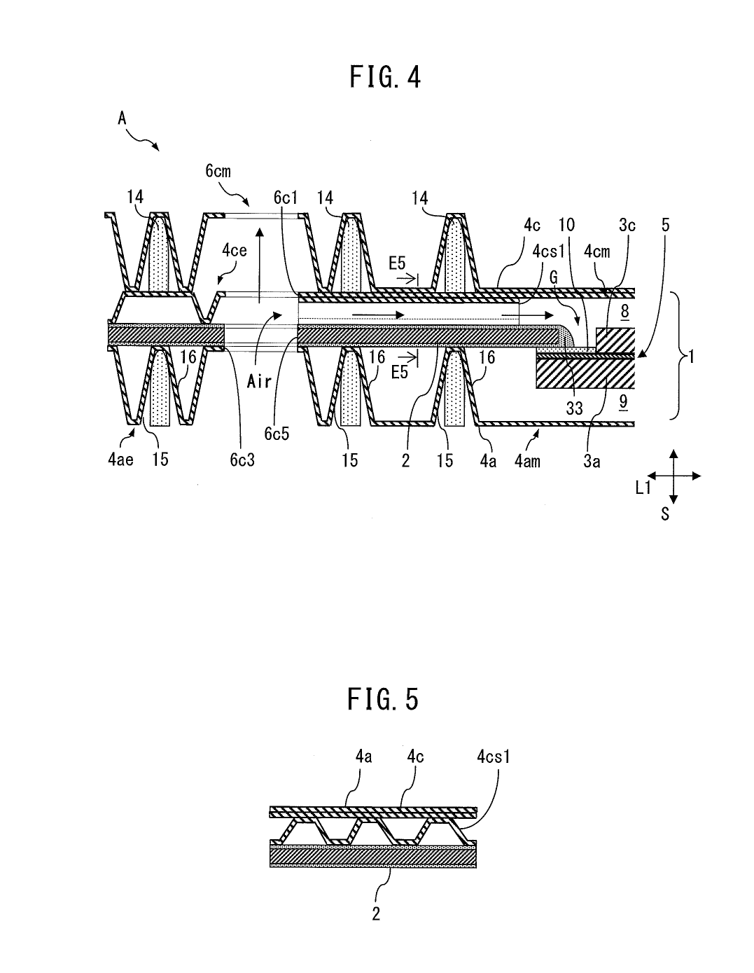

FIG. 4 is a partial cross-sectional view illustrating a configuration example of a fuel cell stack A including a single fuel cell 1. The drawing illustrates the cross section of a part corresponding to a cross section taken along the line E4-E4 of FIG. 1. Referring to FIG. 4, the flow passage member 4cs1 through which oxidant gas flows is placed between the support frame 2 and the cathode separator 4c. The flow passage member 4cs1 forms flow passages for oxidant gas between an oxidant gas manifold 6cm formed by aligning penetration ports 6c1, 6c5, and 6c3 for an oxidant gas manifold in a thickness direction S and plural oxidant gas feed passages 8 in the central portion 4cm of the cathode separator 4c. Similarly, the flow passage member 4cs2 through which oxidant gas flows (see FIG. 1) is placed between the support frame 2 and the cathode separator 4c. The flow passage member 4cs2 forms flow passages for oxidant gas between another oxidant gas manifold formed by aligning penetration ports 6c2, 6c6, and 6c4 for an oxidant gas manifold in the thickness direction S and the plural oxidant gas feed passages 8. FIG. 5 illustrates a cross section taken along the line E5-E5 of FIG. 4. In the embodiment illustrated in FIG. 5, the cross section of the flow passage member 4cs1 in a flow passage direction has a shape having a plurality of grooves parallel to the flow passage direction, similarly to the oxidant gas feed passages 8. In the embodiment illustrated in FIG. 1, the shapes of the flow passage members 4cs2, 4as1, and 4as2 are similar to the shape of the flow passage member 4cs1.

Next, a method of manufacturing a single fuel cell will be described. FIG. 6 to FIG. 11 are partial cross-sectional views illustrating each step of the method for manufacturing the single fuel cell 1.

First, as illustrated in FIG. 6, the membrane electrode assembly 5 in which the anode gas diffusion layer 3a is placed on the other side surface 51 and the one side surface 52 is exposed is provided. The anode gas diffusion layer 3a and the membrane electrode assembly 5 are joined to each other in advance by heating and compressing the anode gas diffusion layer 3a and the membrane electrode assembly 5, e.g., by a hot pressing step.

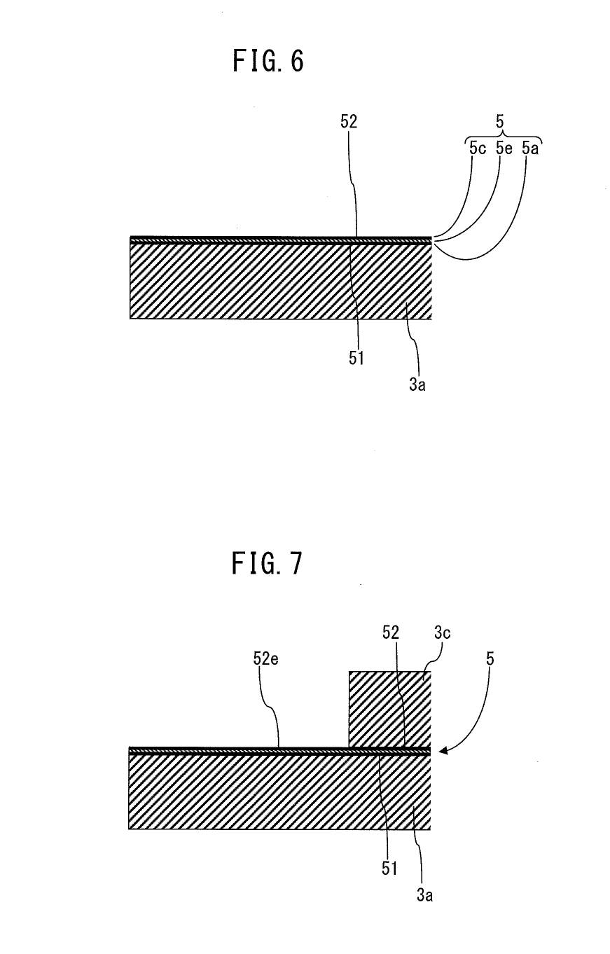

Then, as illustrated in FIG. 7, the cathode gas diffusion layer 3c is placed on the one side surface 52 of the membrane electrode assembly 5 so that the outer peripheral edge portion 52e remains. Then, the cathode gas diffusion layer 3c and the membrane electrode assembly 5 are joined to each other by heating and compressing the cathode gas diffusion layer 3c and the membrane electrode assembly 5, e.g., by a hot pressing step.

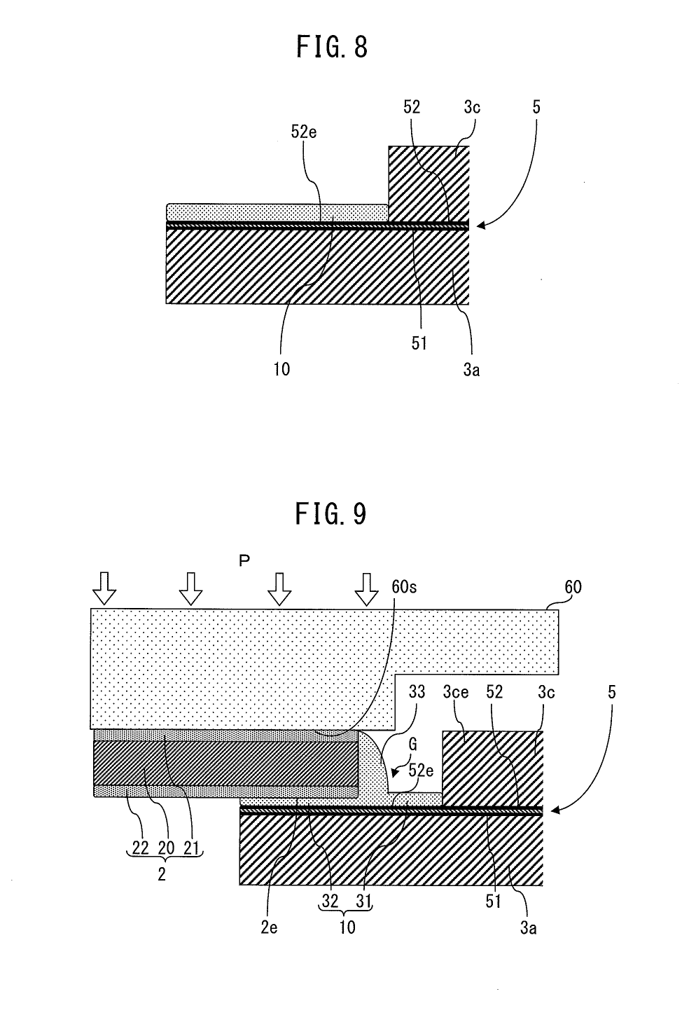

Then, as illustrated in FIG. 8, the adhesive layer 10 with ultraviolet curability is formed on the outer peripheral edge portion 52e. In the embodiment illustrated in FIG. 8, a UV curable adhesive in which a radical-polymerizable resin is used is used as the material of the adhesive layer 10. The adhesive layer 10 is formed on the whole surface of the outer peripheral edge portion 52e. As a method of forming the adhesive layer 10, a method of applying the UV curable adhesive onto the outer peripheral edge portion 52e by screen printing is used. In another example which is not illustrated, the adhesive layer 10 is formed in advance on the one side surface 52 of the membrane electrode assembly 5, and the cathode gas diffusion layer 3c is then formed.

Subsequently, a support frame 2 is prepared as illustrated in FIG. 9. In the embodiment illustrated in FIG. 9, polyethylene terephthalate resin is used as the material of the support frame body 20. The support frame body 20 is biaxially stretched in advance in directions perpendicular to each other, and the biaxial stretching directions are aligned in the longitudinal direction L1 and transverse direction L2 of the support frame 2, respectively. Subsequently, the support frame 2 is placed on the adhesive layer 10. In the embodiment illustrated in FIG. 9, the support frame 2 is placed at an appropriate position on the adhesive layer 10 so that the interior portion 2e of the support frame 2 comes into contact with the outer portion 32 of the adhesive layer 10 and the adhesive layer 10 is exposed partially. Then, the support frame 2 is adhered to the adhesive layer 10 because the adhesive layer 10 has adhesiveness. The linear expansion coefficients of the support frame 2 in the longitudinal direction L1 and the transverse direction L2 can be allowed to be equivalent to the linear expansion coefficients of the cathode separator 4c and the anode separator 4a, respectively, because the biaxial stretching directions of the support frame body 20 correspond to the longitudinal direction L1 and transverse direction L2 of the support frame 2, respectively. In another embodiment which is not illustrated, the biaxial stretching directions are allowed to intersect with the longitudinal direction L1 and transverse direction L2 of the support frame 2, respectively, when biaxially-stretched polyethylene naphthalate resin is placed.

Then, the support frame 2 and the membrane electrode assembly 5 are pressurized to relatively press each other in the embodiment illustrated in FIG. 9. As a pressurization method, the support frame 2 is pressed on the adhesive layer 10 at a pressure P using a weight 60. Thus, the adhesive layer 10 underneath the support frame 2 is deformed, a part thereof moves toward the gap G, and the adhesive protecting layer 33 which covers the end 20e of the support frame body 20 is formed. The adhesive protecting layer 33 can be formed, e.g., by adjusting the thickness of the adhesive layer 10 and pressure P. In another embodiment which is not illustrated, the adhesive protecting layer 33 is formed in advance on the end 20e of the support frame body 20 using an adhesive other than the adhesive layer 10. In such a case, it is not needed to perform the pressurization.

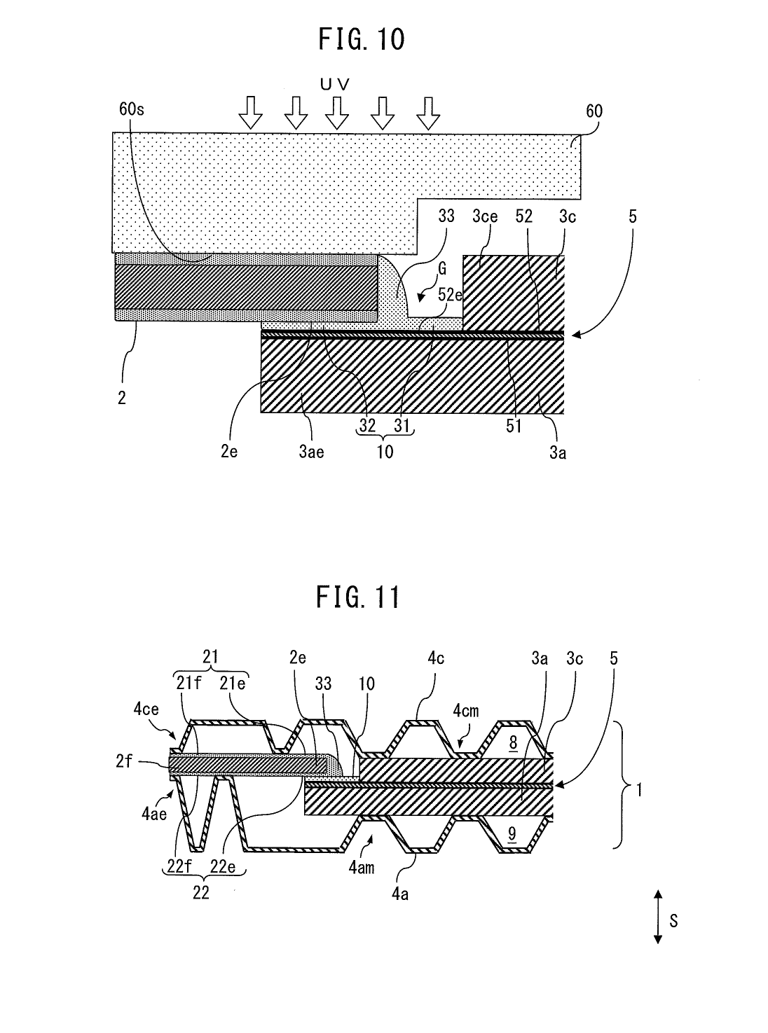

Subsequently, the support frame 2 is irradiated with ultraviolet rays UV having the predetermined wavelength (e.g., 365 nm) while continuing the pressurization at the pressure P as illustrated in FIG. 10. Then, the adhesive layer 10 is cured by receiving the ultraviolet rays because the weight 60 is made of quartz and can transmit ultraviolet rays UV having the predetermined wavelength, and the polyethylene terephthalate resin of the support frame body 20 can also transmit ultraviolet rays UV having the predetermined wavelength. Irradiation conditions (e.g., intensity of ultraviolet rays, irradiation time, and the like) are selected as appropriate depending on the material of the adhesive layer 10. Thus, the outer portion 32 of the adhesive layer 10 and the interior portion 2e of the support frame 2 are adhered to each other, and the outer portion 32 of the adhesive layer 10 and the outer peripheral edge portion 52e of the membrane electrode assembly 5 are adhered to each other. As a result, the support frame 2 and the membrane electrode assembly 5 are adhered to each other via the adhesive layer 10.

In addition, the pressurization at the pressure P can result in more adhesion of the support frame 2 to the adhesive layer 10, to improve adhesive strength. A surface 60s where the support frame 2 and the weight 60 come into contact with each other is coated with a material such as Teflon (registered trademark), whereby the adhesive coating layer 21 is prevented from adhering to the surface 60s of the weight 60 even when the adhesive coating layer 21 melts. In another embodiment which is not illustrated, the support frame 2 is heated without pressurizing the support frame 2 and the membrane electrode assembly 5.

Then, as illustrated in FIG. 11, the anode separator 4a is placed so that an outer portion 22f reverse to the interior portion 22e coming into contact with the adhesive layer 10 in the adhesive coating layer 22 on the one side surface of the support frame 2 comes into contact with the peripheral portion 4ae of the anode separator 4a. In addition, the cathode separator 4c is placed so that an outer portion 21f in the adhesive coating layer 21 on the other side surface of the support frame 2 comes into contact with the peripheral portion 4ce of the cathode separator 4c. Then, an outer portion 2f of the support frame 2 is heated mainly. Thus, the outer portion 22f in the adhesive coating layer 22 and the outer portion 21f in the adhesive coating layer 21 on the both side surfaces of the support frame 2 are mainly melted to adhere the peripheral portion 4ae of the anode separator 4a and the peripheral portion 4ce of the cathode separator 4c, and the support frame 2 to each other. As a result, the membrane electrode assembly 5 and the support frame 2 are sandwiched between a pair of the anode separator 4a and the cathode separator 4c. Then, the adhesive coating layers 22 and 21 cool off and cure to integrate the membrane electrode assembly 5, the cathode gas diffusion layer 3c, the anode gas diffusion layer 3a, the support frame 2, the anode separator 4a, and the cathode separator 4c. In another embodiment which is not illustrated, only the adhesive coating layer 21 is formed on the support frame 2, the adhesive coating layer 22 is not formed thereon, an additional adhesive layer with thermoplasticity is formed on the peripheral portion 4ae of the anode separator 4a instead, and the anode separator 4a and the support frame 2 are adhered to each other with the additional adhesive layer. In still another embodiment which is not illustrated, only the adhesive coating layer 22 is formed on the support frame 2, the adhesive coating layer 21 is not formed thereon, an additional adhesive layer with thermoplasticity is formed on the peripheral portion 4ce of the cathode separator 4c instead, and the cathode separator 4c and the support frame 2 are adhered to each other with the additional adhesive layer. In yet still another embodiment which is not illustrated, an adhesive layer with thermoplasticity such as the adhesive coating layer 22 or the additional adhesive layer described above is formed only on a joint between the peripheral portion 4ae of the anode separator 4a and the support frame 2, and/or an adhesive layer with thermoplasticity such as the adhesive coating layer 21 or the additional adhesive layer described above is formed only on a joint between the peripheral portion 4ce of the cathode separator 4c and the support frame 2.

The single fuel cell 1 is formed in the above steps.

In the manufacturing method of the present embodiment, a biaxially-stretched crystalline polymer is used as the material of the support frame body 20. Thus, the linear expansion coefficient of the support frame 2 can be allowed to be approximately equivalent to the linear expansion coefficient of each of the anode separator 4a and the cathode separator 4c. Thus, the shrinkage of the support frame 2 and the shrinkage of both of the separators 4a and 4c in a subsequent cooling process or during cold operation can be allowed to be approximately equivalent to each other when the support frame 2 is heated to adhere the support frame 2 and both of the separators 4a and 4c to each other with the adhesive coating layers 21 and 22 with thermoplasticity. As a result, the tensile load of the membrane electrode assembly 5 caused by the support frame 2 can be lowered, and generation of cracks in an electrolyte membrane 5e can be inhibited. In particular, when the biaxial stretching directions of the biaxially-stretched polyethylene naphthalate resin are aligned in the longitudinal direction L1 and transverse direction L2 of the support frame 2, respectively, the linear expansion coefficients of the support frame 2 in the longitudinal direction L1 and transverse direction L2 can be allowed to be equivalent to each linear expansion coefficient of the cathode separator 4c and the anode separator 4a, whereby the tensile load that can act on the four sides of the electrode assembly 5 due to the support frame 2 can be further lowered.

In the manufacturing method of the present embodiment, the biaxially-stretched crystalline polymer is used. However, a tri- or more multi-axially-stretched crystalline polymer (e.g., polyethylene terephthalate resin) can also be used as the material of the support frame body 20. In such a case, the linear expansion coefficients of the support frame body 20 in almost all directions are equivalent to the linear expansion coefficients of both of the separators 4c and 4a, and therefore, generation of cracks in the membrane electrode assembly 5 can be further inhibited. In addition, the alignment of one of the stretching directions in the longitudinal direction of the support frame 2 can allow the linear expansion coefficient of the support frame 2 in the longitudinal direction with a great shrinkage due to temperature change to be equivalent to each linear expansion coefficient of the cathode separator 4c and the anode separator 4a, and can result in further inhibition of generation of cracks in the membrane electrode assembly 5. In addition, since there are many stretching directions of the crystalline polymer, the flexibility of cutting in the case of cutting a film to form the support frame body 20 is increased to enable productivity to be improved.

Alternatively, a monoaxially-stretched crystalline polymer (e.g., polyethylene terephthalate resin) can also be used as the material of the support frame body 20. In such a case, the stretching direction is aligned in the longitudinal direction of the support frame 2. Thus, the linear expansion coefficient of the support frame 2 in the longitudinal direction with a great shrinkage due to temperature change can be allowed to be equivalent to each linear expansion coefficient of the cathode separator 4c and the anode separator 4a, and generation of cracks in the membrane electrode assembly 5 can be inhibited.

In the manufacturing method of the present embodiment, an adhesive without any thermosetting property and with ultraviolet curability is used as the adhesive layer 10. When the adhesive that is hardly cured by heating but is cured by ultraviolet rays is used in such a manner, the heating time is not required because the adhesive is cured by ultraviolet irradiation without heating, and the time of the step of forming the adhesive layer 10 can be shortened to enable productivity to be improved because of a very short curing time. If the heating of the adhesive was required, not only the adhesive but also a wide region including the membrane electrode assembly 5 and the support frame 2 in the neighborhood of the adhesive is heated, and damage to the membrane electrode assembly 5 can be caused by the difference between the linear expansion coefficients of the adhesive layer 10 and the membrane electrode assembly 5 in a cooling process after the heating. However, the damage can be inhibited because the heating is not required. Further, if the heating of the adhesive was required, the wide region is heated as described above, and warpage of the support frame 2 and the membrane electrode assembly 5 due to the difference between the linear expansion coefficients of the support frame 2 and the membrane electrode assembly 5 in the cooling process after the heating can occur. However, the warpage can be inhibited because the heating is not required.

In the manufacturing method of the present embodiment, the end 20e of the support frame body 20 is protected by the adhesive protecting layer 33. As illustrated in FIG. 4, the end 20e of the support frame body 20 is exposed to a strong oxidative atmosphere closer to a cathode electrocatalyst layer 5c of the single fuel cell 1. In particular, in the presence of the gap G between the support frame 2 and the cathode gas diffusion layer 3c, a strongly acidic aqueous solution may collect in the gap G to greatly damage the end 20e. However, the protection of the end 20e with the adhesive protecting layer 33 prevents the support frame body 20 from being exposed to an oxidative atmosphere, to enable degradation of the support frame body 20 to be prevented, even when the material of the support frame body 20 is a material vulnerable to an oxidative atmosphere in the cathode electrocatalyst layer 5c side.

In the manufacturing method of the present embodiment, a situation in which the membrane electrode assembly 5 of the outer peripheral edge portion 52e is torn due to degradation or the like can be prevented because the outer peripheral edge portion 52e in the gap G between the support frame 2 and the cathode gas diffusion layer 3c is protected in an interior portion 31 of the adhesive layer 10 and is prevented from being exposed to the outside. In another embodiment which is not illustrated, the support frame 2 and the cathode gas diffusion layer 3c are allowed to approach each other to substantially remove the gap G.

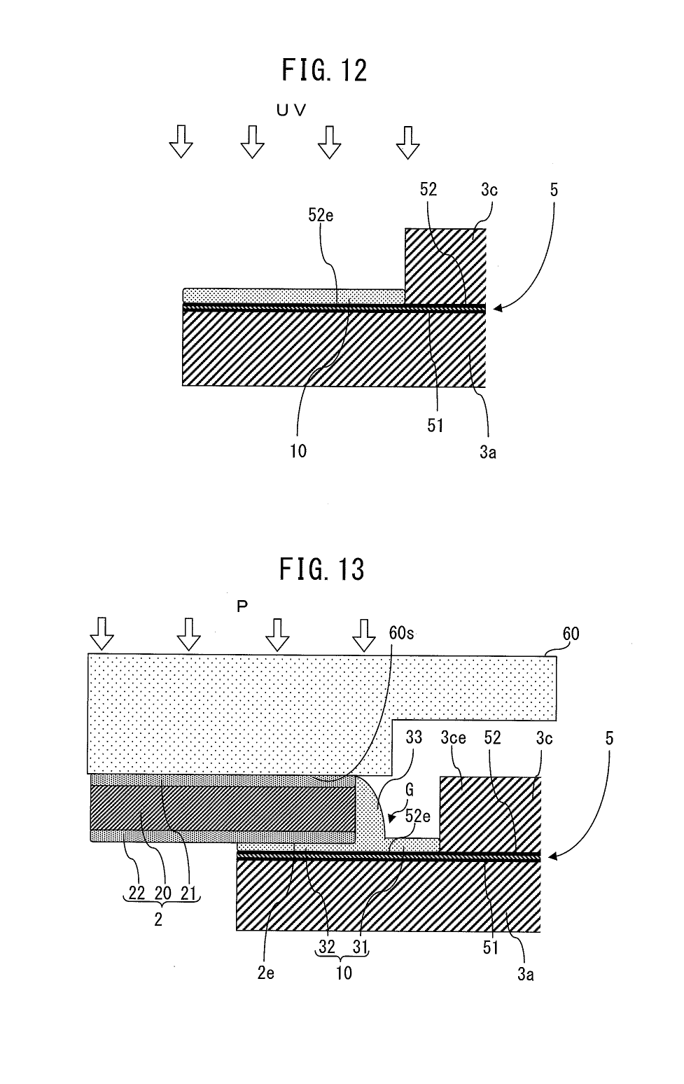

Next, referring to FIG. 12 to FIG. 14, another embodiment will be described. A manufacturing method of the alternative example differs from the above-described manufacturing method illustrated in FIG. 6 to FIG. 11 in view of forming the support frame body 20 with a material that hardly transmits ultraviolet rays with predetermined wavelengths (e.g., 365 nm) used for curing the adhesive layer 10 and of forming the adhesive layer 10 with an adhesive that is imparted with a thermosetting property and has ultraviolet curability. The differences will be mainly described below.

Examples of the material of the support frame body 20 include polyethylene naphthalate resin or polyphenylene sulfide resin of a stretched crystalline polymer. The polyethylene naphthalate resin and the polyphenylene sulfide resin hardly transmit ultraviolet rays with predetermined wavelengths (e.g., 365 nm) used for curing the adhesive layer 10. Thus, the support frame 2 using such a material may be considered to be a material that is hard to transmit ultraviolet rays with predetermined wavelengths in view of a material that can hardly transmit the ultraviolet rays with the predetermined wavelengths used for curing the adhesive layer 10. Examples of the material of the adhesive layer 10 used in such a case include a UV curable adhesive using a radical-polymerizable resin imparted with a thermosetting property or a UV curable adhesive using a cationic polymerizable resin imparted with a thermosetting property. Although UV curable adhesives are hardly cured by heat, a UV curable adhesive imparted with a thermosetting property is thermally cured. In the present embodiment, biaxially-stretched polyethylene naphthalate resin is used as the material of the support frame body 20, and a UV curable adhesive using a radical-polymerizable resin imparted with a thermosetting property is used as the material of the adhesive layer 10. In this the other embodiment, the adhesive layer 10 is formed of an adhesive with tackiness when irradiated with ultraviolet rays and cured to such a degree that at least the shape of the adhesive layer can be maintained. As a method for imparting the adhesive layer 10 with tackiness, a method of preventing complete curing of the adhesive layer 10 by adjusting an irradiation time and an intensity of the ultraviolet rays is used. In another embodiment which is not illustrated, a method of adding an accessory component such as a tackifying agent (tackifier) to the material of the adhesive layer 10 is used.

In the manufacturing method of this the other embodiment, first, the membrane electrode assembly 5 is provided as illustrated in FIG. 6, followed by placing the cathode gas diffusion layer 3c on the one side surface 52 of the membrane electrode assembly 5 as illustrated in FIG. 7.

Then, the adhesive layer 10 is formed on the outer peripheral edge portion 52e using the UV curable adhesive using the radical-polymerizable resin imparted with a thermosetting property, as illustrated in FIG. 12.

Then, the adhesive layer 10 is irradiated with ultraviolet rays UV having with predetermined wavelengths (e.g., 365 nm) so that the adhesive layer 10 is adhered to the outer peripheral edge portion 52e of the membrane electrode assembly 5, as illustrated in FIG. 12. In other words, the adhesive layer 10 is adhered to the membrane electrode assembly 5 due to ultraviolet curing caused mainly by the ultraviolet rays, and protects the outer peripheral edge portion 52e. In the embodiment illustrated in FIG. 12, however, the adhesive layer 10 is prevented from being completely cured. Thus, the adhesive layer 10 is cured to such a degree that the shape of the adhesive layer 10 can be maintained and does not flow; however, the adhesive layer 10 has adhesiveness (tack strength), and can be deformed to some extent by applying relatively strong force to the adhesive layer 10. The conditions of irradiation with such ultraviolet rays UV (e.g., intensity of ultraviolet rays, irradiation time, and the like) are selected as appropriate depending on the material of the adhesive layer 10. In another embodiment which is not illustrated, a tackifying agent is added as an accessory component to the adhesive of the adhesive layer 10, whereby tack strength is exerted.

Subsequently, the support frame 2 is provided as illustrated in FIG. 13. In the embodiment illustrated in FIG. 13, biaxially-stretched polyethylene naphthalate resin is used as the material of the support frame body 20. Subsequently, the support frame 2 is placed on the adhesive layer 10. In the embodiment illustrated in FIG. 13, the support frame 2 and the membrane electrode assembly 5 are pressurized to relatively press each other. Then, the support frame 2 is adhered to the adhesive layer 10, held by the adhesive layer 10, and thereby temporarily fixed to the outer peripheral edge portion 52e of the membrane electrode assembly 5 because adhesiveness remains in the adhesive layer 10.

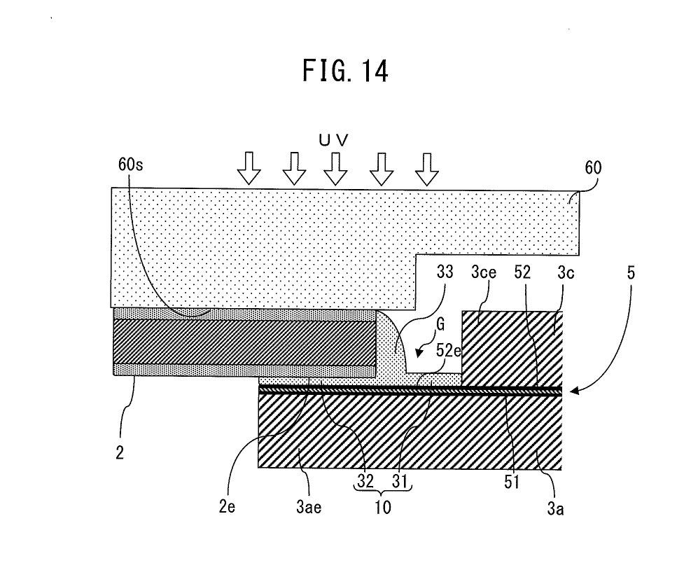

Subsequently, the support frame 2 is heated while continuing the pressurization at a pressure P as illustrated in FIG. 14. As a heating method, there is used a method of irradiating the support frame 2 with ultraviolet rays UV having predetermined wavelengths and allowing the support frame 2 to absorb the ultraviolet rays UV, whereby the support frame 2 generates heat by itself to heat the support frame 2. In such a case, the support frame 2 is irradiated with the ultraviolet rays UV so that when the support frame 2 generates the heat, the temperature of the support frame 2 is not less than the temperature at which the adhesive layer 10 is cured. In the embodiment illustrated in FIG. 14, the interior portion 2e in the support frame 2 is irradiated with ultraviolet rays UV having predetermined wavelengths so that the temperature of the interior portion 2e coming into contact with the adhesive layer 10 in the support frame 2 is not less than the temperature at which the adhesive layer 10 is cured. The conditions of such irradiation (e.g., intensity of ultraviolet rays, irradiation time, and the like) are selected as appropriate depending on the materials of the support frame 2 and the adhesive layer 10. Thus, the adhesive layer 10 underneath the interior portion 2e of support frame 2 starts to be thermally cured to thereby adhere the adhesive layer 10 and the support frame 2 to each other. In other words, the adhesive layer 10 is adhered to the support frame 2 by thermal curing caused mainly by heating. As a result, the support frame 2 and the membrane electrode assembly 5 are adhered to each other via the adhesive layer 10. The adhesive layer 10 that is not covered with the support frame 2 may also be irradiated with part of ultraviolet rays UV of which irradiation is performed toward the interior portion 2e of the support frame. In such a case, curing of the adhesive layer 10 that is not covered with the support frame 2 further proceeds due to ultraviolet rays UV. At that time, the intensity of ultraviolet rays needed for heating caused by the absorption of ultraviolet rays UV is greater than the intensity of ultraviolet rays in the step of FIG. 12, and therefore, the curing of the adhesive layer 10 that is not covered with the support frame 2 further proceeds. In such a case, a portion that comes into contact with the support frame 2 in an adhesive protecting layer 33 is thermally cured while the portion that does not comes into contact with the support frame 2 in the adhesive protecting layer 33 is ultraviolet-cured. Thus, the support frame 2 and the membrane electrode assembly 5 are adhered via the adhesive layer 10.

Subsequently, as illustrated in FIG. 11, the cathode separator 4c and the anode separator 4a are placed on both of the side surfaces of the support frame 2 and the membrane electrode assembly 5, respectively.

The single fuel cell 1 is formed in the above steps.

In the manufacturing method of the present embodiment, there is adopted a method of imparting the ultraviolet curable adhesive of the adhesive layer 10 with a thermosetting property and allowing the support frame 2 to absorb ultraviolet rays to generate heat as a heat source for thermal curing. Thus, the adhesion between the adhesive layer 10 and the membrane electrode assembly 5 can be achieved by curing the adhesive layer 10 mainly due to ultraviolet irradiation as illustrated in the step of FIG. 12. In contrast, the adhesion between the adhesive layer 10 and the support frame 2 can be achieved by thermal curing mainly due to local heating as illustrated in the step of FIG. 14. In other words, the interior portion 2e can be locally heated to cure the adhesive layer 10 by irradiating the interior portion 2e coming into contact with the adhesive layer 10 in the support frame 2 with ultraviolet rays with the utilization of the use of the material that does not transmit ultraviolet rays as the material of the support frame 2 with advantage. In other words, the adhesive layer 10 needing to be heated can be locally heated without heating a wide region including the membrane electrode assembly 5 and the support frame 2 in the neighborhood of the adhesive layer 10. Thus, the adhesion of a portion that is not reached by ultraviolet rays can be enabled while making use of the advantage of using the ultraviolet curable adhesive described above.

In addition to the ultraviolet curable adhesive, an adhesive with thermoplasticity that adheres at a low temperature of around several tens of degrees that is slightly higher than room temperature (e.g., adhesive polyethylene resin) or an adhesive with a thermosetting property that is cured at low temperature (e.g., acrylic resin, epoxy resin, or polyisobutylene resin) can also be considered to be as a candidate for the material of the adhesive layer 10. However, it is difficult to use each adhesive in a single fuel cell for a vehicle in view of the problems of adhesive strength and manufacture as described above. Based on the above, the ultraviolet curable adhesive imparted with a thermosetting property is used as the material of the adhesive layer 10 in the single fuel cell of a vehicle.

Even in such a case, an effect similar to that of the single fuel cell 1 obtained by the manufacturing method of the above-described embodiment illustrated in FIG. 6 to FIG. 11 can be obtained.

In the above-described embodiment, the one side surface 52 (the side surface closer to the cathode gas diffusion layer 3c) of the membrane electrode assembly 5 is a cathode electrode side surface while the other side surface 51 (the side surface closer to the anode gas diffusion layer 3a) of the membrane electrode assembly 5 is an anode electrode side surface. In still another embodiment which is not illustrated, the one side surface of the membrane electrode assembly 5 is an anode electrode side surface while the other side surface of the membrane electrode assembly 5 is a cathode electrode side surface.

### REFERENCE SIGNS LIST

1 Single fuel cell

2 Support frame

3a Anode gas diffusion layer

3c Cathode gas diffusion layer

5 Membrane electrode assembly

10 Adhesive layer

20 Support frame body

21, 22 Adhesive coating layer

52e Outer peripheral edge portion

What is claimed is:

1. A single fuel cell, comprising:
a membrane electrode assembly including an electrolyte membrane and electrocatalyst layers formed on both side surfaces of the electrolyte membrane, respectively;
gas diffusion layers placed on both side surfaces of the membrane electrode assembly, respectively, so that an outer peripheral edge portion remains in one side surface of the membrane electrode assembly;
an adhesive layer formed to cover the outer peripheral edge portion;
a support frame fixed on the adhesive layer; and
separators placed on both side surfaces of the support frame and the gas diffusion layers, respectively, so that peripheral portions of the separators are fixed on the support frame and central portions of the separators abut on the gas diffusion layers,
wherein the support frame comprises:
a support frame body; and
an adhesive coating layer formed of an adhesive with thermoplasticity on at least one of both side surfaces of the support frame body,
the separators are formed of a metal; and
the support frame body is formed of a stretched crystalline polymer.

2. The single fuel cell according to claim 1, wherein the support frame body is formed of a multiaxially-stretched crystalline polymer.

3. The single fuel cell according to claim 1, wherein one of stretching directions of the crystalline polymer is parallel to a longitudinal direction of the support frame body.

4. The single fuel cell according to claim 1, wherein
the adhesive layer is formed of an adhesive with ultraviolet curability; and
the support frame body is formed of a crystalline polymer which transmits an ultraviolet ray with a predetermined wavelength that cures the adhesive.

5. The single fuel cell according to claim 4, wherein the crystalline polymer includes at least one of polyethylene terephthalate resin, syndiotactic polystyrene resin and polypropylene resin.

6. The single fuel cell according to claim 1, wherein
the adhesive layer is formed of an adhesive with ultraviolet curability and a thermosetting property; and
the support frame body is formed of a crystalline polymer that hardly transmits an ultraviolet ray with a predetermined wavelength that cures the adhesive.

7. The single fuel cell according to claim 6, wherein the crystalline polymer includes at least one of polyethylene naphthalate resin and polyphenylene sulfide resin.

8. The single fuel cell according to claim 1, wherein the separators are formed of stainless steel or titanium.

9. The single fuel cell according to claim 1, wherein the one side surface of the membrane electrode assembly is a cathode electrode side surface.

10. A method for manufacturing a single fuel cell, the single fuel cell including: a membrane electrode assembly including an electrolyte membrane and electrocatalyst layers formed on both side surfaces of the electrolyte membrane, respectively; gas diffusion layers placed on both side surfaces of the membrane electrode assembly; a support frame supporting the membrane electrode assembly on a periphery of the membrane electrode assembly; and separators placed on both side surfaces of the support frame and the gas diffusion layers, respectively, so that peripheral portions of the separators are fixed on the support frame and central portions of the separators abut on the gas diffusion layers,
wherein the support frame includes:
a support frame body; and
an adhesive coating layer formed of an adhesive with thermoplasticity on at least one of both side surfaces of the support frame body;
the separators are formed of a metal; and
the support frame body is formed of a stretched crystalline polymer,
the method for manufacturing the single fuel cell, comprising:
providing the membrane electrode assembly in which the gas diffusion layers are placed on both side surfaces of the membrane electrode assembly, respectively, while an outer peripheral edge portion remains in one side surface of the membrane electrode assembly;
forming an adhesive layer to cover the outer peripheral edge portion;
placing an interior portion of the support frame on the adhesive layer and adhering the support frame and the membrane electrode assembly to each other; and
placing the peripheral portions of the separators on both side surfaces of an outer portion of the support frame adhered to the membrane electrode assembly and heating the support frame and the separators to be adhered to each other.
